(19) United States
(12) Patent Application Publication
(10) Pub. No.: US 2007/0020357 A1
(43) Pub. Date: Jan. 25, 2007

(54) Method and device for determining milk quality

(75) Inventors: Zehava Uni, Nes Zion (IL); Eliahu Gal, Montreal (CA); Uri Agam, Montreal (CA)

Correspondence Address: DARBY & DARBY P.C., P. O. BOX 5257, NEW YORK, NY, 10150-5257, US

(73) Assignees: Yissum Research Development Company; Eliahu Gal, Montreal (CA); Uri Agam, Montreal (CA)

(21) Appl. No.: 11/267,818

(22) Filed: Nov. 4, 2005

Related U.S. Application Data
(60) Provisional application No. 60/700,743, filed on Jul. 20, 2005.

(51) Int. Cl. A23L 1/30

(52) U.S. Cl. 426/72

(57) ABSTRACT

A system for characterizing the nutrient quality of milk including at least one optical analyzer operative to provide output indications of at least two of fat content, protein content and lactose content of milk and a nutrient quality calculator receiving the output indications of at least two of fat content, protein content and lactose content of milk and providing an output indication of nutrient quality based on a combination of the output indications.

### REFERENCE TO RELATED APPLICATION

This application is related to U.S. Provisional Patent Application Ser. No. 60/700,743, filed on Jul. 20, 2005 entitled “Method and Device for Determining Milk Quality”, the disclosure of which is hereby incorporated by reference and convention priority of which is hereby claimed pursuant to 37 CFR 1.78(a) (4) and (5)(i).

### FIELD OF THE INVENTION

The present invention relates to determination of the nutrient quality of mother's milk.

### BACKGROUND OF THE INVENTION

The following U.S. Patents are believed to represent the current state of the art: U.S. Pat. Nos. 6,157,297; 6,493,071; 6,542,833; 6,748,251 & 6,793,624.

### SUMMARY OF THE INVENTION

The present invention seeks to provide a system and method for determination of the nutrient quality of mother's milk.

There is thus provided in accordance with a preferred embodiment of the present invention a system for characterizing the nutrient quality of milk including at least one optical analyzer operative to provide output indications of at least two of fat content, protein content and lactose content of milk and a nutrient quality calculator receiving the output indications of at least two of fat content, protein content and lactose content of milk and providing an output indication of nutrient quality based on a combination of the output indications.

Preferably, the at least one optical analyzer includes laser absorbance measurement functionality operative at at least two different wavelengths. Additionally or alternatively, the nutrient quality calculator provides an output indication of caloric value of the milk.

There is also provided in accordance with another preferred embodiment of the present invention a method for characterizing the nutrient quality of mother's milk including immediately following expression of mother's milk, performing at least one optical analysis to provide output indications of at least two of fat content, protein content and lactose content of milk.

Preferably, the method also includes calculating a nutrient quality at least partially based on the output indications of at least two of fat content, protein content and lactose content of milk; and providing an output indication of nutrient quality based on a combination of the output indications. Additionally, the calculating includes calculating caloric value of the milk and the providing includes providing an output indication of the caloric value of the milk.

Preferably, the method and also includes calculating caloric value of the milk at least partially based on the output indications of at least two of fat content, protein content and lactose content of milk and providing an output indication of the caloric value based on a combination of the output indications.

Additionally or alternatively, the method also includes modifying the mother's milk prior to the performing at least one optical analysis. Additionally, the modifying includes adding an enzyme to the milk.

### BRIEF DESCRIPTION OF THE DRAWINGS

The present invention will be more fully appreciated and understood from the following detailed description, taken in conjunction with the drawings in which:

FIG. 1 is a simplified illustration of a system for characterizing the nutrient quality of mother's milk constructed and operative in accordance with a preferred embodiment of the present invention;

FIGS. 2A and 2B are simplified illustrations of two operative orientations of an optical analyzer useful in the system of FIG. 1;

FIGS. 3A and 3B are simplified illustrations of two operative orientations of an alternative optical analyzer useful in the system of FIG. 1; and

FIGS. 4A, 4B & 4C are simplified flowcharts illustrating the operation of the nutrient quality calculator of the embodiment of FIG. 1.

### DETAILED DESCRIPTION OF A PREFERRED EMBODIMENT

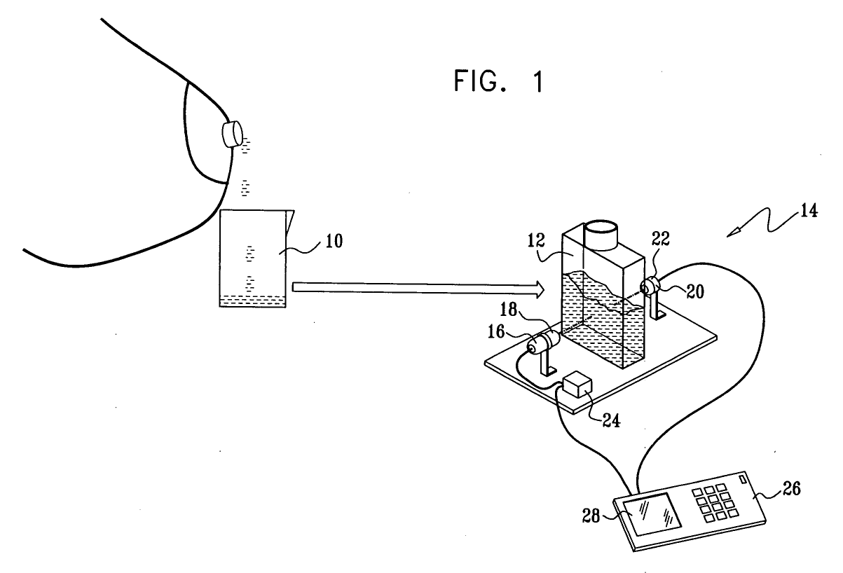

Reference is now made to FIG. 1, which is a simplified illustration of a system for characterizing the nutrient quality of mother's milk constructed and operative in accordance with a preferred embodiment of the present invention. As seen in FIG. 1, mother's milk is expressed directly into a cup 10 or other suitable container and immediately poured into a cuvette 12 which is mounted or mountable onto an optical analyzer 14, preferably operative to provide output indications of at least two and preferably all three of fat content, protein content and lactose content of milk.

The optical analyzer 14 preferably comprises a radiation source 16, preferably including a plurality of sources 18 of electromagnetic radiation, adapted to irradiate mother's milk in cuvette 12, and a radiation detector 20, preferably including a plurality of electromagnetic radiation detectors 22, operative to sense the radiation passing through the mother's milk in cuvette 12.

Alternatively, the radiation source 16 may comprise an ultrasonic energy source, adapted to irradiate mother's milk in cuvette 12, and the radiation detector 20 may include an ultrasonic energy detector.

As a further alternative, a biological or chemical determination of at least two and preferably all three of fat content, protein content and lactose content of mother's milk may be employed.

In another alternative, one of fat content, protein content and lactose content may be determined by other conventional means, such as providing a current measuring conductivity of mother's milk in cuvette 12.

Radiation source 16 is preferably operated by a driver 24, which in turn receives commands from a system computer 26.

Outputs from radiation detector 20 are supplied to system computer 26 which is preferably operative for receiving output indications of fat content, protein content and lactose content of milk and providing an output indication of nutrient quality based on a combination of at least two of those output indications. The output indication of nutrient quality is preferably displayed on a display 28.

It is appreciated that the mother's milk in cuvette 12 may be chemically modified, such as by the addition of an enzyme thereto, to cause a change in the absorbance spectrum thereof. This modification provides for a more suitable wavelength for monitoring radiation passing therethrough and enables a more cost effective radiation source to be utilized in the system.

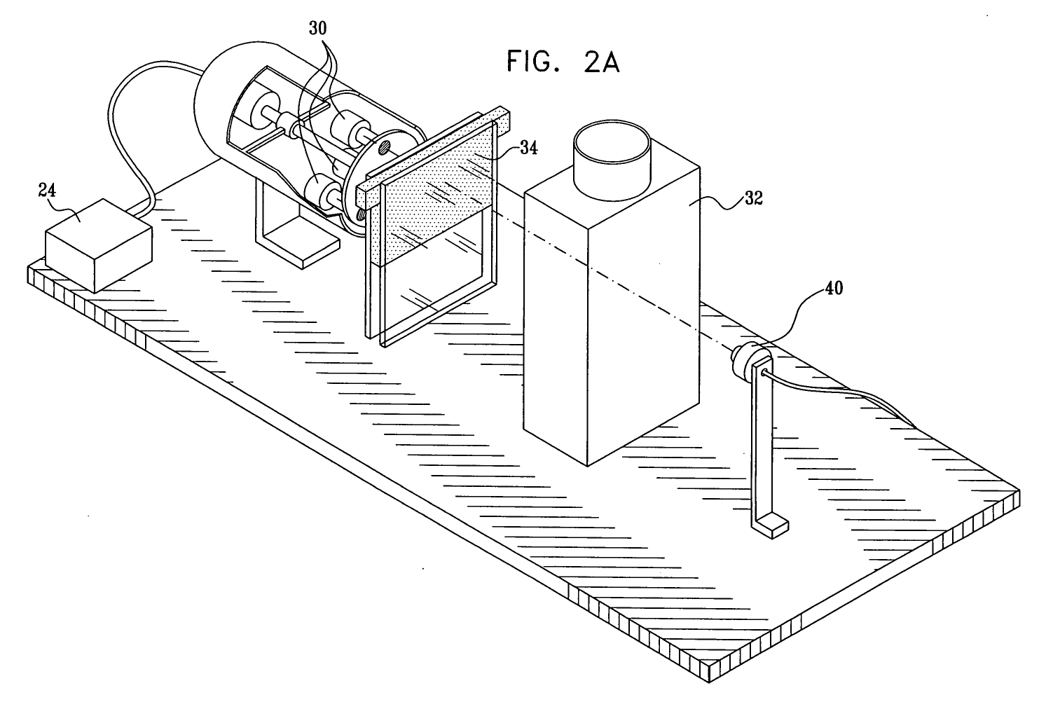

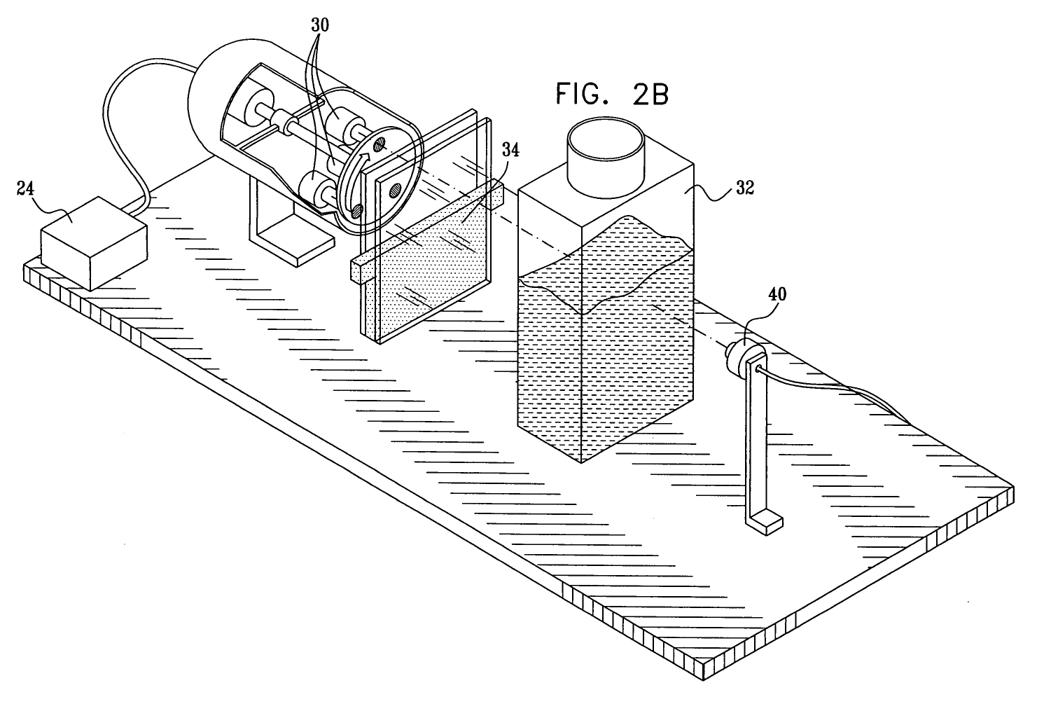

Reference is now made to FIGS. 2A and 2B, which are simplified illustrations of two operative orientations of an optical analyzer useful in the system of FIG. 1. Here the optical analyzer employs a rotatably mounted selectably positionable plurality of sources 30 of electromagnetic radiation, preferably LEDs, preferably emitting at frequencies in the ranges of 1300-2000 nm to determine fat content, 700-1100 nm to determine protein content and 700-1100 nm to determine Lactose content, adapted to irradiate mother's milk in a cuvette 32 via a selectably positionable filter 34, such as a neutral density filter, and a radiation detector 40, preferably having a detection range wide enough to detect the outputs of all of sources 30. Detector 40 is preferably located downstream of cuvette 32, as shown.

FIG. 2A shows the optical analyzer in a calibration mode, wherein cuvette 32 is empty of milk and the filter 34 is positioned along the optical path between each of sources 30 and detector 40, while FIG. 2B shows the optical analyzer in a measurement mode, wherein cuvette 32 contains mother's milk and the filter 34 is positioned outside of the optical path between each of sources 30 and detector 40.

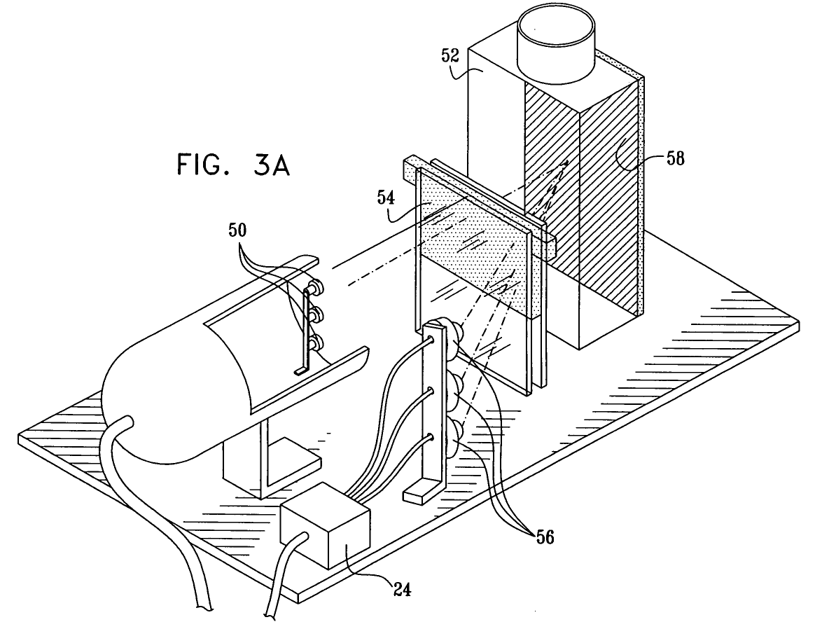

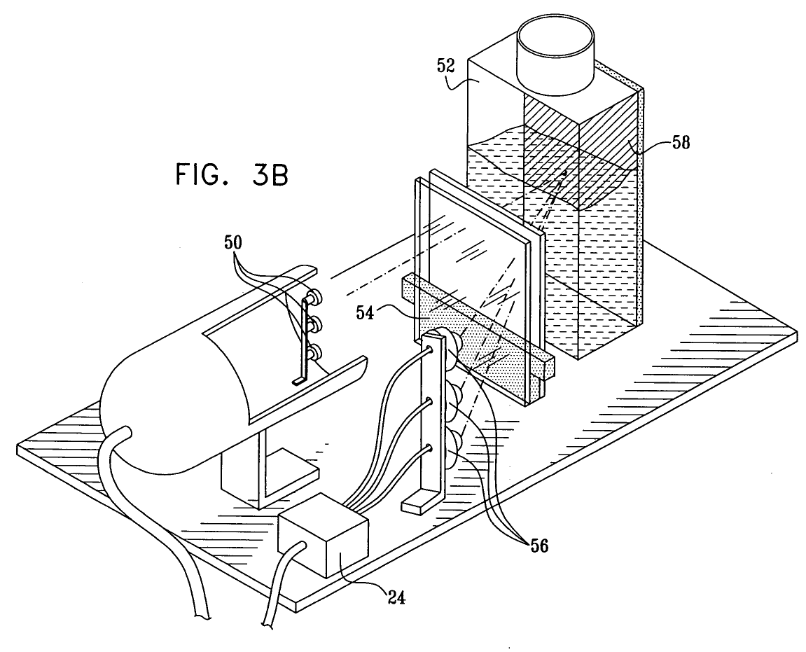

Reference is now made to FIGS. 3A and 3B, which are simplified illustrations of two operative orientations of an alternative optical analyzer useful in the system of FIG. 1. Here the optical analyzer employs a plurality of sources 50 of electromagnetic radiation, preferably LEDs, preferably emitting at frequencies in the ranges of 1300-2000 nm to determine fat content, 700-1100 nm to determine protein content and 700-1100 nm to determine Lactose content, adapted to irradiate mother's milk in a cuvette 52 via a selectably positionable filter 54, such as a neutral density filter, and a corresponding plurality of radiation detectors 56 each matched to the wavelength range of a corresponding source 50. Here a mirror 58 is either disposed downstream of cuvette 52 or mounted or coated onto a wall of cuvette 52, as shown, facing the interior of the cuvette and arranged to reflect radiation received via the mother's milk in cuvette 52 from sources 50 back through the mother's milk in cuvette 52 to detectors 56.

FIG. 3A shows the optical analyzer in a calibration mode, wherein cuvette 52 is empty of milk and the filter 54 is positioned along the optical paths between each of sources 50 and detectors 56, while FIG. 3B shows the optical analyzer in a measurement mode, wherein cuvette 52 contains mother's milk and the filter 54 is positioned outside of the optical paths between each of sources 50 and detectors 56.

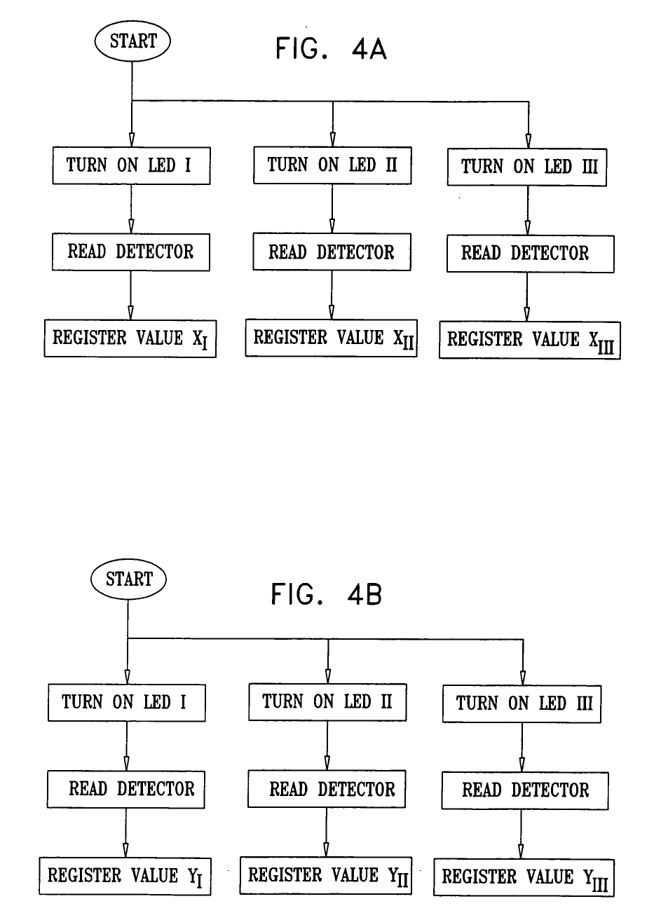

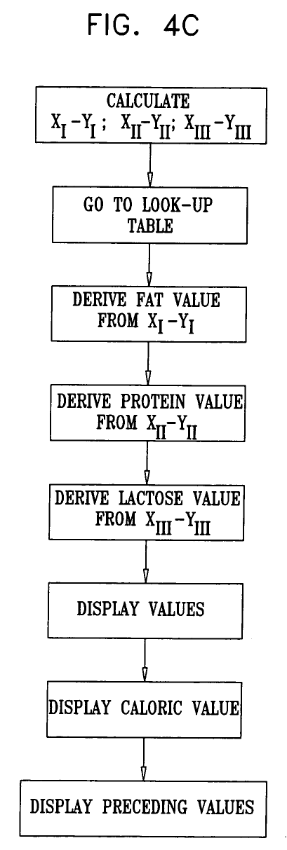

Reference is now made to FIGS. 4A, 4B & 4C, which are simplified flowcharts illustrating the operation of the nutrient quality calculator of the embodiment of FIG. 1. FIG. 4A shows a calibration mode of operation, corresponding to the orientations of the optical analyzer shown in FIGS. 2A and 3A. Each of three LEDS, designated I, II and III, is caused to emit radiation through an empty cuvette and a corresponding detector reading is taken and recorded, as values X_{I}, X_{II}, and X_{III}.

FIG. 4B shows a measurement mode of operation, corresponding to the orientations of the optical analyzer shown in FIGS. 2B and 3B. Each of three LEDS, designated I, II and III, is caused to emit radiation through milk contained in the cuvette and a corresponding detector reading is taken and recorded, as values Y_{I}, Y_{II} and Y_{III}.

FIGS. 4C illustrates a calculation mode of operation wherein the values X_{I}-Y_{I}, X_{II}-Y_{II} and X_{III}-Y_{III} are calculated. Preferably using a look-up table, the fat content value is determined from X_{I}-Y_{I}, the protein content value is determined from X_{II}-Y_{II} and the lactose content value is determined from X_{III}-Y_{III}. A composite indication of nutrient quality of the mother's milk may be determined and displayed from the aforementioned data or similar data. An indication of caloric value may also be determined and displayed.

Preceding values may be stored, averaged and displayed as appropriate.

It will be appreciated by persons skilled in the art that the present invention is not limited by what has been claimed hereinabove. Rather the scope of the invention includes both combinations and subcombinations of various features described hereinabove as well as variations and modifications thereof as would occur to persons skilled in the art and which are not in the prior art.

1. A system for characterizing the nutrient quality of milk comprising:
at least one optical analyzer operative to provide output indications of at least two of fat content, protein content and lactose content of milk; and
a nutrient quality calculator receiving said output indications of at least two of fat content, protein content and lactose content of milk and providing an output indication of nutrient quality based on a combination of said output indications.

2. A system according to claim 1 and wherein said at least one optical analyzer comprises laser absorbance measurement functionality operative at at least two different wavelengths.

3. A system according to claim 2 and wherein said nutrient quality calculator provides an output indication of caloric value of said milk.

4. A system according to claim 1 and wherein said nutrient quality calculator provides an output indication of caloric value of said milk.

5. A method for characterizing the nutrient quality of mother's milk comprising:
immediately following expression of mother's milk, performing at least one optical analysis to provide output indications of at least two of fat content, protein content and lactose content of milk.

6. A method for characterizing the nutrient quality of mother's milk according to claim 5 and also comprising:
calculating a nutrient quality at least partially based on said output indications of at least two of fat content, protein content and lactose content of milk; and
providing an output indication of nutrient quality based on a combination of said output indications.

7. A method for characterizing the nutrient quality of mother's milk according to claim 6 and wherein:
said calculating comprises calculating caloric value of said milk; and
said providing comprises providing an output indication of said caloric value of said milk.

8. A method for characterizing the nutrient quality of mother's milk according to claim 5 and also comprising:
calculating caloric value of said milk at least partially based on said output indications of at least two of fat content, protein content and lactose content of milk; and
providing an output indication of said caloric value based on a combination of said output indications.

9. A method for characterizing the nutrient quality of mother's milk according to claim 5 and also comprising modifying said mother's milk prior to said performing at least one optical analysis.

10. A method for characterizing the nutrient quality of mother's milk according to claim 9 and wherein said modifying includes adding an enzyme to said milk.
